(19) United States
(12) Patent Application Publication
(10) Pub. No.: US 2009/0172772 A1
(43) Pub. Date: Jul. 2, 2009

(54) METHOD AND SYSTEM FOR PROCESSING SECURITY DATA OF A COMPUTER NETWORK

(75) Inventor: Alexandre Souille, Paris (FR)

Correspondence Address: YOUNG & THOMPSON, 209 Madison Street, Suite 500, ALEXANDRIA, VA, 22314, US

(73) Assignee: OLFEO, PARIS (FR)

(21) Appl. No.: 12/304,954

(22) PCT Filed: Jun. 13, 2007
(86) PCT No.: PCT/FR07/00974

§ 371 Date: Dec. 15, 2008

(30) Foreign Application Priority Data
Jun. 16, 2006 (FR) 0605360

(51) Int. Cl. G06F 21/00

(52) U.S. Cl. 726/1

(57) ABSTRACT

Method of processing security data of a computer network (R) including a plurality of users (U₁-U₄), this method including the following steps:—analyzing data relating to at least one content or service accessed by at least one of the users (U₁-U₄) through the network (R); —as a function of the analysis, determining data relating to the behavior of the user (U₁-U₄), the data making up a so-called behavioral signature (SCU₁-SCU₄) of the user (U₁-U₄); —comparing the behavioral signature (SCU₁-SCU₄) with at least one so-called reference signature (SR₁-SRₙ), the reference signature including data representing a predefined model behavior; and —triggering at least one so-called security action as a function of the comparison.

The present invention relates to a method for processing security data of a computer network. It also relates to a system for processing security data implementing the method according to the invention.

The field of the invention is the field of computer network security and more particularly the management of the internal security of a computer network comprising a plurality of users.

The security of a computer network of a business or an organization gives rise to concerns relating, on the one hand, to criminal law through users visiting illegal sites, and, on the other, to the productivity of the users sharing this network. The concerns also relate to the network's bandwidth, the risks of viruses on the network, as well as the confidentiality of the information circulating on the network.

As well as these concerns, there are questions relating to the employment law which regulates access to a user's personal data.

All these concerns have led participants in the field of computer network security to develop tools allowing a security policy to be put in place as well as management of this policy. Among these tools there can be mentioned for example antivirus software, firewalls, etc. Currently, one of the standard security tools for business is the firewall. This filters incoming and outgoing access and blocks external attacks. In order to locate hackers, certain firewalls have recently proposed intrusion detection functions (IDS—Intrusion Detection System) which will be capable of discovering that a workstation is vulnerable to an attempted attack by a particular behaviour (IP address scan, etc.). This firewall will then dynamically block access to this machine.

However, organizations today are aware that security vulnerabilities also arise from internal usage, whether by negligence or by malicious intent. Currently, internal security tools are few in number and the majority of these tools use static security rules. Moreover, these internal security tools do not allow satisfactory security of a computer network to be achieved. Static security rules cannot be optimum and are either too strict for a given user or not strict enough. They do not allow a security policy to be achieved which is adaptable to each user, complies with data protection regulations (for example, reading named usage logs can be prohibited), and allows satisfactory performance to be ensured in terms of productivity, bandwidth and protection against external attacks. Moreover, these statistical rules become ineffective when a change takes place at user level.

An objective of the invention is thus to overcome the above-mentioned drawbacks by proposing a method and system for processing security data of a computer network allowing a more effective protection of this network to be provided while complying with the law on the protection of personal data and allowing good protection in terms of criminal risk, bandwidth abuse, productivity and antivirus protection.

Another objective of the invention is to propose a method and a system for processing security data of a computer network which dynamically adapts to the network users by taking into account their diversities.

The invention proposes to overcome the above-mentioned problems by a method for processing security data of a computer network comprising a plurality of users, this method comprising the following stages:
analysing data relating to at least one content or one service accessed by at least one of said users across said network;
depending on said analysis, determining data relating to the behaviour of said user, said data composing a so-called behavioural signature of said user;
comparing said behavioural signature with at least one signature, called a reference signature, said reference signature comprising data representing a predefined behaviour pattern; and
activating at least one action, called securization, according to said comparison.

The method according to the invention allows the security data of a computer network to be processed according to the behaviour of the users of the network. The security of the computer network thus depends on the behaviour of a user or a group of users on the network. Such a security policy achieved with the method according to the invention is more efficient than the security policies proposed in the prior art, as it is based on a number of important known or easily identifiable parameters internal to the network, and on users' actual individual usage of the network.

Moreover, it is adaptable to each user and allows an efficiency in terms of productivity, bandwidth, and protection. Also, as the method according to the invention is dynamic and automated, it allows computer network security which complies with employment law and criminal law.

Moreover, the method according to the invention advantageously makes it possible to achieve computer network security which takes into account the behavioural differences which can occur on the one hand, between the users on a network and on the other hand, between a single user on two different occasions. Thus, different security policies can correspond to one user according to his behaviour on different occasions. On one occasion he can have a “deviant” behaviour and be subjected to a “severe” security policy, and on another occasion have a “non-deviant” behaviour and enjoy a “less severe” security policy. The invention also makes it possible to develop the awareness of a network user, by making him monitor his own behaviour.

The method according to the invention proposes a processing of the security data of a computer network in the form of security data defined according to the behaviour of each of the users or groups of users on the network, and the ability to dynamically modify this security data according to an analysis of the behaviour of these users or group of users.

Advantageously, the method according to the invention comprises moreover a comparison of the behavioural signature of a user with at least one reference signature from a plurality of predefined reference signatures. This comparison can be done by comparing the data making up the behavioural signature with at least one reference signature.

The method can moreover comprise a definition of at least one reference signature for at least one user and/or a group of users. A reference signature can be defined by defining the different components of the signature. These components can comprise an identifier of the user with whom the behavioural signature is associated and other data relating to a content/service or a category of content/service which can be accessed across the computer network. This data can comprise criteria or functions defining criteria relating to access to a content/service such as the number of instances of access, the time of access to this content/service or its duration, also the type of access to this content/service, the type of access capable of being a download, a program execution, the category of the content/service, etc.

According to a particular embodiment of the method according to the invention, the definition of a reference signature can relate to an activity of at least one user. The rules, criteria, functions defining the criteria, or the data comprising a reference signature can relate to an activity, a language, or a function of a user or a group of users within the computer network.

Advantageously, the method according to the invention can moreover comprise a definition of a security policy for at least one user, said security policy comprising data relating to at least one access rule of said user to at least one content and/or service across the computer network. As the user profiles of a network can be different, it may be necessary to associate a security policy with at least one user. In particular it can be very advantageous to associate a security policy with each user in order to ensure an overall security policy of the computer network which is adaptable to each user. Such a security policy makes it possible to develop the awareness of all users of the security of the computer network, and thus make them avoid behaviour which can endanger the security of the computer network. Such a policy also makes it possible to achieve good performance in terms of bandwidth and productivity.

Moreover, the method according to the invention allows the security data of an overall network to be processed on the basis of the internal parameters of the network. Thus dangerous behaviour which may occur on the network can be detected and securization actions aimed at preventing them can be adopted.

The securization action can relate to at least one security policy associated with at least one user. After determining the behavioural signature of a user and comparing it to at least one reference signature, it is possible if necessary to launch at least one securization action according to his security policy. For example, the behavioural signature of a user shows that he is improperly accessing a strategic program. A consultation of his security policy can be carried out to determine whether or not he has access rights to this application. According to his security policy, a securization action can be launched. This security action can for example comprise sending an e-mail message to the user regarding improper use of the strategic program in question. The security policy can comprise a simple authorisation or prohibition of access of this user to the application in question or a criterion on the number and/or time of access of this user to this application. According to this data the securization action can be launched or not.

Advantageously, a signature can comprise statistical data relating to at least one content and/or service accessed by at least one user. A behavioural signature can comprise the statistical data relating to:
the user to which it is associated;
an identifier and/or an address of at least one content/service, and/or a category of contents/services which a user or a group of users has accessed or attempted to access; and
the number, time and duration of access of the user to at least one content/service accessed by a user or a group of users.
   This data can comprise figures, more or less complex functions, letters, etc.

Similarly, a reference signature can comprise criteria concerning each of the concepts listed above.

A signature can in particular comprise statistical data relating to at least one category of contents and/or services accessed by at least one user, said category being predefined. A content or a service can be classified in a category, which can be classified in a family of categories.

The statistical data, bearing on a content/service, a category or a category family, can comprise data relating to a number of instances of access by a user to at least one content and/or service, or to a category of contents/services, or also to a family of categories of contents/services.

Similarly, the statistical data can comprise data relating to an access time of a user to at least one content and/or service, or to a category of contents/services, or to a family of categories of contents/services.

The statistical data can also comprise data relating to the date, time or moment of access of a user (U₁-U₄) to at least one content and/or service. Thus the security policy applied to a user can relate to the date of access of a user to a content/service. For example, his access policy can be more flexible during his breaks.

The method according to the invention can advantageously comprise classifying a content and/or a service in at least one category, this classification being carried out according to an analysis of the data relating to said content and/or service. The contents/services can be classified in at least one category from a plurality of categories which can be classified in at least one family from a plurality of families. The classification of the contents/services in a category, as well as the classification of a category in a family, can be carried out by an internal user of the network and stored on devices, such as at least one server or database, which are internal to the network, or by an external person on means external to the network.

In this latter case, the method can comprise updating said classification, this updating being carried out by connection to a remote server.

The method according to the invention can in particular comprise a graphic representation of a behavioural or reference signature. This graphic representation can be produced in two or three dimensions and along one or more axes.

In a particular version of the method according to the invention, a securization action can comprise transmitting data to at least one user. This transmission can comprise data relating to the user's behavioural signature, in order to make him aware of his own behaviour, if the latter involves a risk or does not comply with the security policy associated with the user in question. The data can be sent by e-mail or by any other messaging means, and can also comprise warning data.

According to an advantageous feature of the method according to the invention, a securization action can comprise a modification of a security policy. For example if a user who has a security policy giving him access rights to a strategic application makes improper use of this application, he can then be subject to a modification to his security policy so that he will not longer have access to this application.

According to another feature of the method according to the invention, a securization action can comprise a modification of a user's access to the computer network, if his behaviour is deviant with regard to the security policy allocated to him, and he can be made to carry out a particular operation, such as contacting a network administrator, in order to remove this modification which can be for example a denial of access to the network.

Advantageously, a securization action can comprise a modification of the content accessible to the user. In fact, when the user desires to access a content, whether internal to the network or external to the network, if his behavioural signature resembles a predefined reference signature, the content returned to him will be modified by the system according to the reference signature.

In the particular example, which is in no way limitative, where the method according to the invention is applied to URL filtering, when a user desires to access content of video streaming type and if his behavioural signature shows that he makes frequent searches for non-approved categories of sites, the video is replaced by a prevention or warning message or adapted content. Apart from adapted content, the method according to the invention can comprise a reduction in the retrieval speed of the content so that the data takes longer to reach his computer. The method according to the invention can also comprise suppressing at least a part of the content which is considered to be unimportant or of little benefit to the user, such as for example banner advertising on a website, and/or adding another content which is considered more important or more beneficial for the user according to his profile. When the user makes a request for access to information, the method according to the invention can comprise sending information which is more appropriate to his past behaviour. Thus two users having different behaviours or profiles will not receive the same information from the same search or request.

The method according to the invention can in particular be used for managing the access of at least one user to contents across an internet-type network.

According to another aspect of the invention, a system is proposed for processing security data of a computer network, implementing the method according to the invention.

The system according to the invention can comprise storage means and/or a database arranged for storing at least one predefined reference signature.

Other advantages and features will become further apparent on examination of the detailed description of an embodiment which is in no way limitative, and the attached drawings in which:

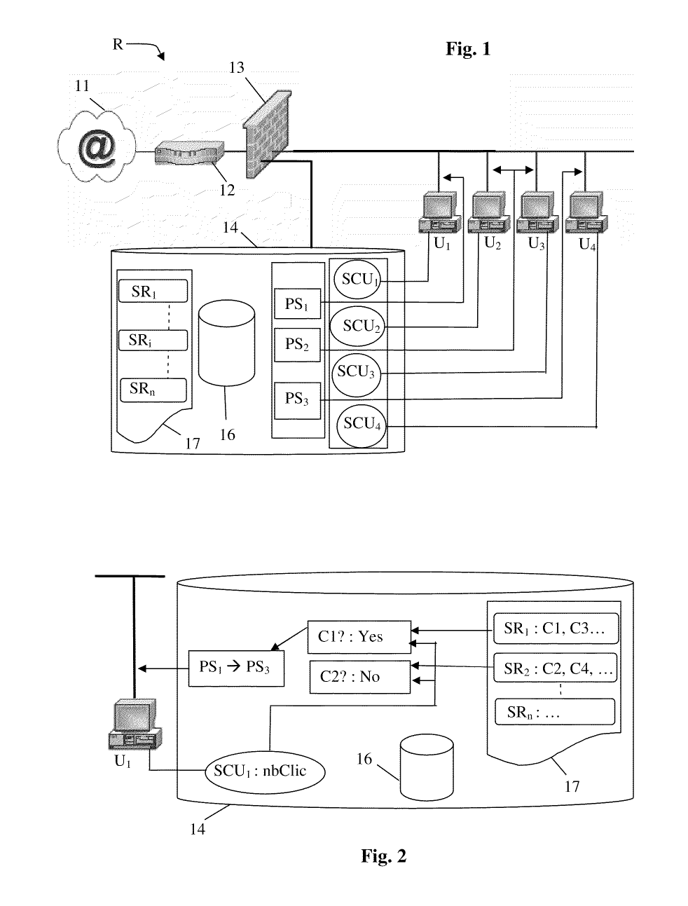

FIG. 1 represents a computer network, the security data of which are processed in accordance with the method according to the invention;

FIG. 2 is a diagrammatic representation of the management of a user security policy in accordance with the method according to the invention;

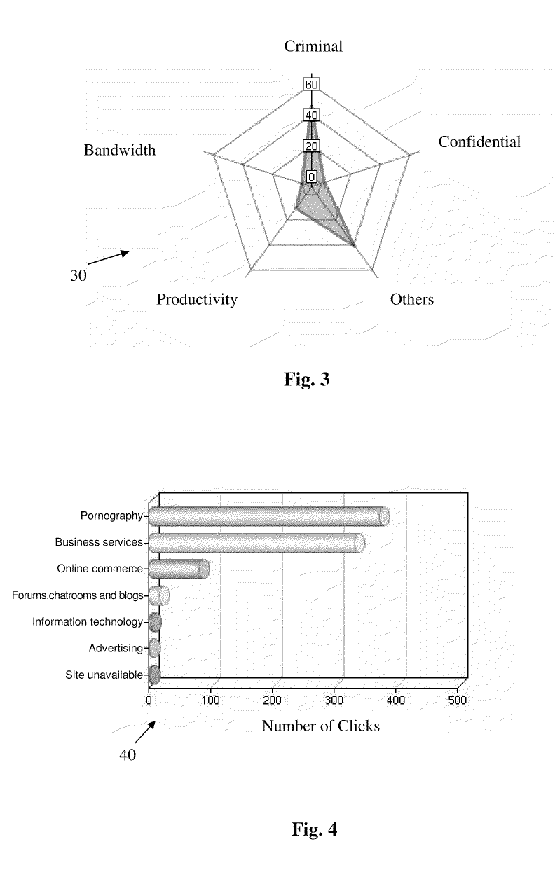

FIG. 3 is a example representing a behavioural signature of a user in accordance with the method according to the invention;

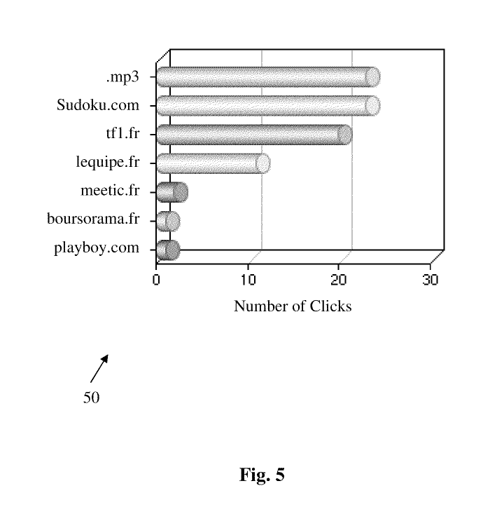

FIG. 4 is a diagrammatic representation of statistical data relating to contents visited by a user, classified by categories, according to the invention; and

FIG. 5 is a diagrammatic representation of statistical data relating to contents visited by a user according to the invention.

The particular embodiment detailed below relates to a computer network R, having an organisation composed of a plurality of users U₁, U₂, U₃ and U₄, as shown in FIG. 1. A behavioural signature SCU₁, SCU₂, SCU₃ and SCU₄, and a security policy PS₁, PS₂ and PS₃ are associated with each of the users Uᵢ. The network R moreover comprises a modem 12 connecting the network R to the internet 11 and a server 14 comprising databases 16 and 17.

In the particular example particular considered here, the security policies PSᵢ correspond to access policies for sites across the internet 11. These policies PSᵢ are more restrictive or less restrictive. They are allocated to each user or group of users by an administrator and make it possible to limit the access of each user or group of users to certain categories of sites. Each of the behavioural signatures SCUᵢ comprises statistical data relating to the internet sites that the user Uᵢ has accessed or tried to access.

The database 16 comprises a list of barred sites. These barred sites are classified by site categories and by family of site categories. The categories can relate to pornography, services to companies, online commerce, etc. The families can relate to criminality, bandwidth, productivity, etc. The list of sites barred for each category or family, and/or the list of barred categories, and/or the list of families of categories of barred sites can be updated by a classification of a new, hitherto unknown site, category or family.

This classification can be carried out either by an administrator of the network R, or by an external site. In the latter case, the list present on the database 16 will be updated by connection to the external site in question, for example across the internet 11.

In the present example, the security policy PS₁ associated with the user U₁ strictly prohibits the access of user U₁ to 15 categories of sites from a set of 60 categories of sites listed, classified and stored on the database 16. Each category of sites comprises a list of authorized and/or barred internet sites. The barred sites or site categories correspond to illicit contents. In the case where a site requested by the user is not recognized or is not classified in any category, the policy PS₁ allows the user to access this site.

The security policy PS₃ associated with user U₄ is different from PS₁ only in the management of unrecognized sites. Within the framework of this policy PS₃, access to unknown sites is barred.

The database 17 comprises reference signatures SR₁ to SRₙ. In the present case these reference signatures comprise conditions on the parameters appearing in the behavioural signatures SCUᵢ associated with each user Uᵢ or group of users: number of sites visited, date and time, categories of the requested sites, etc.

For example, the reference signature SR₁ comprises a condition C1 relating to the parameters of access to barred sites and more particularly to the number of clicks on the barred sites. Similarly, the reference signature SR₂ also comprises a condition C2 relating to the parameters of access to barred sites and more particularly to the number of clicks on the barred sites. In this example, the condition C1 is expressed by nbClic >10 and the condition C2 by nbClic >40, with nbClic representing the number of clicks on barred sites in one day.

The user U₁, to whom the security policy PS₁ is allocated, of course has no access to the barred sites, but access attempts are in fact recorded in the behavioural signature, which here can be limited to the individual log of access to the internet 11. All that is then required is to count them. This counting can be carried out at predetermined intervals.

FIG. 4 is a representation 40 of the result of counting by site category and FIG. 5 a representation 50 of the result of counting by site. In these figures, the horizontal axis represents the number of clicks and the vertical axis, the corresponding site or site category. The result of the counting also makes it possible to produce a graphic representation of a behavioural signature. FIG. 3 gives an example of a graphic representation 30 of a behavioural signature of a user by family of internet sites. This graphic representation 30 makes it possible to display the number of clicks by site family.

Once the number of access attempts has been counted, it is compared to conditions C1 and C2 as represented diagrammatically in FIG. 2. If the condition C1 is verified, then several securization actions, which are parametrizable beforehand, are launched:
1. The security policy PS₃ is now associated with the user U₁, not the security policy PS₁
2. An e-mail is sent to the user U₁ to inform him of the policy change,
3. An e-mail is sent to the network administrator for information.
   If the condition C2 is verified, the securization actions launched are as follows:
1. The user's access to the internet 11 is permanently cut off,
2. The administrator receives a warning SMS message.

This example shows that behavioural filtering makes it possible to adapt security policies according to the real usage by the users. It allows an improved security of a computer network R of an organization to be defined using an individual risk analysis. This is particularly pertinent in the case where regulations on the protection of personal data prevent an organization manually carrying out named analysis of internet access logs.

The invention is not limited to the example which has just been described and can be applied to any security policy of a computer network

1-20. (canceled)

21. Method for processing security data of a computer network (R) comprising a plurality of users (U₁-U4), located on said network (R), this method comprising the following stages:
analysing data relating to at least one content or one service accessed by at least one of said users (U₁-U₄) across said network (R);
depending on said analysis, determining data relating to the behaviour of said user (U₁-U₄), said data being internal to said network (R) and composing a so-called behavioural signature (SCU₁-SCU₄) of said user (U₁-U4);
comparing said behavioural signature (SCU₁-SCU₄) with at least one signature (SR₁-SRₙ), called a reference signature, said reference signature comprising data representing a predefined behaviour pattern; and
activating at least one securization action of said network (R), according to said comparison.

22. Method according to claim 21, characterized in that it comprises moreover a definition of a security policy (PS₁-PS₃) for at least one user (U₁-U₄), said security policy (PS₁-PS₃) comprising data relating to at least one access rule of said user (U₁-U₄) to at least one content and/or service across the computer network (R).

23. Method according to claim 21, characterized in that the securization action relates to at least one security policy (PS₁-PS₃) associated with at least one user (U₁-U₄).

24. Method according to claim 21, characterized in that a securization action comprises a modification of a security policy (PS₁-PS₃).

25. Method according to claim 21, characterized in that a securization action comprises a transmission of data to at least one user (U₁-U₄).

26. Method according to claim 21, characterized in that a securization action comprises a modification of the access of a user (U₁-U₄) to the computer network (R).

27. Method according to claim 21, characterized in that it comprises moreover a definition of at least one reference signature (SR₁-SRₙ) for at least one user (U₁-U₄) and/or a group of users.

28. Method according to claim 27, characterized in that the definition of a reference signature (SR₁-SRₙ) relates to an activity of at least one user (U₁-U₄).

29. Method according to claim 21, characterized in that a behavioural signature (SCU₁-SCU₄) comprises statistical data relating to at least one content and/or service accessed by at least one user (U₁-U₄).

30. Method according to claim 21, characterized in that a behavioural signature (SCU₁-SCU₄) comprises statistical data relating to at least one category of contents and/or services accessed by at least one user (U₁-U₄), said category being predefined.

31. Method according to claim 29, characterized in that the statistical data comprise data relating to a number of instances of access of a user (U₁-U₄) to at least one content and/or service.

32. Method according to claim 29, characterized in that the statistical data comprise data relating to the time of access of a user (U₁-U₄) and to at least one content and/or service.

33. Method according to claim 29, characterized in that the statistical data comprise data relating to a duration of access of a user (U₁-U₄) to at least one content and/or service.

34. Method according to claim 21, characterized in that it also comprises a graphical representation (30) of a behavioural signature (SCU₁-SCU₄).

35. Method according to claim 21, characterized in that the data relating to at least one content or service comprises data relating to a category or family in which said content was previously classified according to the information that it represents.

36. Method according to claim 21, characterized in that it comprises moreover a classification into at least one category of a content and/or a service, said classification being carried out according to an analysis of the data relating to said content and/or service.

37. Method according to claim 36, characterized in that it comprises moreover an updating of said classification, said updating being carried out by connection to a remote server.
